(19) United States
(12) Patent Application Publication
(10) Pub. No.: US 2024/0296534 A1
(43) Pub. Date: Sep. 5, 2024

(54) IMAGE FUSION METHOD AND APPARATUS, ELECTRONIC DEVICE, AND READABLE STORAGE MEDIUM

(71) Applicant: MEGVII (BEIJING) TECHNOLOGY CO., LTD., Beijing (CN)

(72) Inventor: Yuzhi WANG, Beijing (CN)

(21) Appl. No.: 17/768,143

(22) PCT Filed: Sep. 21, 2020
(86) PCT No.: PCT/CN2020/116487

§ 371 Date: Apr. 11, 2022

(30) Foreign Application Priority Data
Oct. 25, 2019 (CN) 201911024851.9

(51) Int. Cl. G06T 5/92; G06T 5/50; G06V 10/60

(52) U.S. Cl. CPC G06T 5/92; G06T 5/50; G06V 10/60; G06T 2207/20221

(57) ABSTRACT

Some embodiments of the present disclosure provide an image fusion method, an apparatus, an electronic device, and a readable storage medium. The method includes: acquiring at least two RAW images to be processed in a same scenario; regarding one of the at least two RAW images to be processed as a reference frame, the others as supplementary frames, and determining a luminance relationship between each of the supplementary frames and the reference frame; for each of the supplementary frames, linearly adjusting the luminance of pixels in the supplementary frame based on the luminance relationship to obtain an adjusted supplementary frame; and fusing each of the adjusted supplementary frames and the reference frame to obtain a fused image.

The present disclosure claims the priority of the Chinese patent application filed on Oct. 25, 2019 before the Chinese Patent Office with the application number of 201911024851.9 and the title of “IMAGE FUSION METHOD AND APPARATUS, ELECTRONIC DEVICE, AND READABLE STORAGE MEDIUM”, which are incorporated herein in its entirety by reference.

### TECHNICAL FIELD

The present disclosure relates to the technical field of image processing, and specifically, the present disclosure relates to an image fusion method, an apparatus, an electronic device, and a readable storage medium.

### BACKGROUND

Multi-exposure High-Dynamic Range (HDR) synthesis means that the camera simultaneously or continuously shoots a set of images with a plurality of exposure parameters. The typical shooting strategy is to shoot an over-exposed image, an under-exposed image, and a normal-exposed image, and then fuse a plurality of shot images through the algorithm to obtain an image with a wider dynamic range.

However, in practical applications, when a plurality of exposure images are fused, due to the existence of image information of a plurality of luminance in the images to be fused, the final fused image is prone to the phenomenon of unnatural luminance transition.

### SUMMARY

The purpose of the present disclosure is to solve at least one of the above technical defects, and in particularly the technical defect that the final fused image is prone to the phenomenon of unnatural luminance transition.

In the first aspect, some embodiments of the present disclosure provide an image fusion method, the method comprises:
acquiring at least two RAW images to be processed in a same scenario;
regarding one of the at least two RAW images to be processed as a reference frame, the others as supplementary frames, and determining a luminance relationship between each of the supplementary frames and the reference frame;
for each of the supplementary frames, linearly adjusting the luminance of pixels in the supplementary frame based on the luminance relationship to obtain an adjusted supplementary frame; and
fusing each of the adjusted supplementary frames and the reference frame to obtain a fused image.

In the optional embodiments of the first aspect, the method further comprises:
acquiring a weight characteristic diagram of each of the RAW images to be processed, wherein the weight characteristic diagram comprises a weight value of each pixel in the RAW images to be processed; and
the step of fusing each of the adjusted supplementary frames and the reference frame comprises:
fusing each of the adjusted supplementary frames and the reference frame based on the weight characteristic diagram of each of the RAW images to be processed.

In the optional embodiments of the first aspect, when the RAW images to be processed are high dynamic range images, the step of acquiring a weight characteristic diagram of each of the RAW images to be processed comprises:
converting each of the RAW images to be processed into a low dynamic range image to obtain converted RAW images to be processed; and
inputting each of the converted RAW images to be processed to a neural network to obtain the weight characteristic diagram of each of the RAW images to be processed.

In the optional embodiments of the first aspect, the neural network is trained by the following methods:
acquiring a training sample set, wherein the training sample set comprises training images corresponding to at least one scenario, the training images of each scenario are at least two images, for at least two images of each scenario, one image is regarded as a sample reference frame, and the other images are regarded as sample supplementary frames;
performing a linear luminance transformation on each of the training images to obtain various transformed training images, and based on the transformed training images, training an initial network until a loss function of the initial network converges, and determining the initial network when the loss function converges as the neural network;
wherein, the initial network is a neural network with an image as an input and a weight characteristic diagram of the image as an output, the loss function characterizes the error between sample fusion images corresponding to the same scenario and the sample reference frame, the sample fusion images are obtained by fusing the transformed training images according to a weight characteristic diagram of each training image corresponding to the same scenario.

In the optional embodiments of the first aspect, the step of acquiring a training sample set comprises:
acquiring an initial training sample set, wherein the initial training sample set comprises initial images corresponding to at least one scenario, and the initial images of each scenario are at least two images;
on the condition that the initial images are the low dynamic range images, regarding the initial images as training images of each scenario;
on the condition that the initial images are the high dynamic range images, converting each of the initial images into a low dynamic range image corresponding to each of the initial images; and
regarding the low dynamic range image corresponding to each of the initial images of each scenario as a training image of each scenario.

In the optional embodiments of the first aspect, the step of determining the luminance relationship between each of the supplementary frames and the reference frame comprises:
acquiring an exposure parameter of each of the RAW images to be processed; and
for each of the supplementary frames, according to an exposure parameter of the reference frame and an exposure parameter of the supplementary frame, determining the luminance relationship between the supplementary frame and the reference frame.

In the optional embodiments of the first aspect, the exposure parameter comprises an aperture size, a shutter time and a sensor gain;
the step of according to an exposure parameter of the reference frame and an exposure parameter of the supplementary frame, determining the luminance relationship between the supplementary frame and the reference frame includes:
determining an incidence relation of the supplementary frame and the reference frame corresponding to each of the exposure parameters; and
determining the luminance relationship between the supplementary frame and the reference frame according to the incidence relation of the supplementary frame and the reference frame corresponding to each of the exposure parameters.

In the optional embodiments of the first aspect, if the exposure parameter is the aperture size, the incidence relation is the ratio of the square value of the aperture size of the supplementary frame to the square value of the aperture size of the reference frame;
if the exposure parameter is the shutter time, the incidence relation is the ratio of the shutter time of the reference frame to the shutter time of the supplementary frame; and
if the exposure parameter is the sensor gain, the incidence relation is the ratio of the sensor gain of the supplementary frame to the sensor gain of the reference frame.

In the optional embodiments of the first aspect, the step of determining the luminance relationship between each of the supplementary frames and the reference frame comprises:
determining a weight mask based on a luminance of each pixel in the reference frame;
adjusting a luminance of each pixel in each of the RAW images to be processed based on the weight mask;
for each of the RAW images to be processed, determining a luminance of the RAW images to be processed based on the luminance of each pixel of adjusted RAW images to be processed; and
for each of the supplementary frames, determining the luminance relationship between the supplementary frame and the reference frame based on a luminance of the supplementary frame and a luminance of the reference frame.

In the second aspect, some embodiments of the present disclosure provide an image fusion apparatus, the apparatus comprises:
an image acquisition module configured for acquiring at least two RAW images to be processed in a same scenario;
a luminance relationship determination module configured for regarding one of the at least two RAW images to be processed as a reference frame, the others as supplementary frames, and determining a luminance relationship between each of the supplementary frame and the reference frame;
a luminance adjustment module configured for, for each of the supplementary frames, linearly adjusting the luminance of pixels in the supplementary frame based on the luminance relationship to obtain an adjusted supplementary frame; and
an image fusion module configured for fusing each of the adjusted supplementary frames and the reference frame to obtain a fused image.

In the optional embodiments of the second aspect, the apparatus further comprises a weight characteristic diagram acquisition module, specifically configured to:
acquire a weight characteristic diagram of each of the RAW images to be processed,
wherein the weight characteristic diagram comprises a weight value of each pixel in the RAW images to be processed; and
when the weight characteristic diagram acquisition module fuse each of the adjusted supplementary frames and the reference frame, specifically configured to:
fuse each of the adjusted supplementary frames and the reference frame based on the weight characteristic diagram of each of the RAW images to be processed.

In the optional embodiments of the second aspect, when the weight characteristic diagram acquisition module is acquiring the weight characteristic diagram of each of the RAW images to be processed, specifically configured to:
when the RAW images to be processed are high dynamic range images, convert each of the RAW images to be processed into a low dynamic range image to obtain converted RAW images to be processed; and
input each of the converted RAW images to be processed to a neural network to obtain the weight characteristic diagram of each of the RAW images to be processed.

In the optional embodiments of the second aspect, the apparatus further comprises a training module, wherein the training module obtains the neural network through the following methods:
acquire a training sample set, wherein the training sample set comprises training images corresponding to at least one scenario, the training images of each scenario are at least two images, for at least two images of each scenario, one image is regarded as a sample reference frame, and the other images are regarded as sample supplementary frames;
perform a linear luminance transformation on each of the training images to obtain various transformed training images, and based on the transformed training images, training an initial network until a loss function of the initial network converges, and determining the initial network when the loss function converges as the neural network;
wherein, the initial network is a neural network with an image as an input and a weight characteristic diagram of the image as an output, the loss function characterizes the error between sample fusion images corresponding to the same scenario and the sample reference frame, the sample fusion images are obtained by fusing the transformed training images according to a weight characteristic diagram of each training image corresponding to the same scenario.

In the optional embodiments of the second aspect, when the training module is acquiring a training sample set, the training module is specifically configured to:
acquire an initial training sample set, wherein the initial training sample set comprises initial images corresponding to at least one scenario, and the initial images of each scenario are at least two images;
on the condition that the initial images are the low dynamic range images, regarding the initial images as training images of each scenario;
on the condition that the initial images are the high dynamic range images, converting each of the initial images into a low dynamic range image corresponding to each of the initial images; and
regard the low dynamic range image corresponding to each of the initial images of each scenario as a training image of each scenario.

In the optional embodiments of the second aspect, when the luminance relationship determination module is determining a luminance relationship between each of the supplementary frame and the reference frame, the luminance relationship determination module is specifically configured to:
acquire an exposure parameter of each of the RAW images to be processed; and
for each of the supplementary frames, according to an exposure parameter of the reference frame and an exposure parameter of the supplementary frame, determining the luminance relationship between the supplementary frame and the reference frame.

In the optional embodiments of the second aspect, the exposure parameter comprises an aperture size, a shutter time and a sensor gain;
the step of according to an exposure parameter of the reference frame and an exposure parameter of the supplementary frame, determining the luminance relationship between the supplementary frame and the reference frame includes:
determining an incidence relation of the supplementary frame and the reference frame corresponding to each of the exposure parameters; and
determining the luminance relationship between the supplementary frame and the reference frame according to the incidence relation of the supplementary frame and the reference frame corresponding to each of the exposure parameters;

In the optional embodiments of the second aspect, if the exposure parameter is the aperture size, the incidence relation is the ratio of the square value of the aperture size of the supplementary frame to the square value of the aperture size of the reference frame;
if the exposure parameter is the shutter time, the incidence relation is the ratio of the shutter time of the reference frame to the shutter time of the supplementary frame; and
if the exposure parameter is the sensor gain, the incidence relation is the ratio of the sensor gain of the supplementary frame to the sensor gain of the reference frame.

In the optional embodiments of the second aspect, when the luminance relationship determination module is determining the luminance relationship between each of the supplementary frames and the reference frame, the luminance relationship determination module is specifically configured to:
determine a weight mask based on a luminance of each pixel in the reference frame;
adjust a luminance of each pixel in each of the RAW images to be processed based on the weight mask;
for each of the RAW images to be processed, determine a luminance of the RAW images to be processed based on the luminance of each pixel of adjusted RAW images to be processed; and
for each of the supplementary frames, determine the luminance relationship between the supplementary frame and the reference frame based on a luminance of the supplementary frame and a luminance of the reference frame.

In the third aspect, some embodiments of the present disclosure provide an electronic device, the electronic device comprises a processor and a memory, the memory is configured to store machine readable instructions, when the instructions are executed by the processor, the processor executes any one of the methods in the first aspect.

In the fourth aspect, some embodiments of the present disclosure provide a computer-readable storage medium, storing a computer program, wherein the computer-readable storage medium is configured to store computer instructions, when the computer instructions are executed on the computer, the computer is capable to execute any one of the methods in the first aspect.

In the fifth aspect, some embodiments of the present disclosure provide a computer program, wherein the computer program comprises a computer-readable code, and when the computer-readable code is executed on an electronic device, the electronic device executes any one of the methods in the first aspect.

The beneficial effects of the technical solution provided by the embodiments of the present disclosure are described as follows:

In the embodiments of the present disclosure, after acquiring the RAW images to be processed, based on the luminance relationship between each of the supplementary frames and the reference frame, the luminance of each of the supplementary frames may be linearly adjusted, and each of the adjusted supplementary frames and the reference frame are fused to obtain a fused image. In the embodiments of the present disclosure, since the RAW images to be processed have a linear luminance relationship, a linear luminance transformation can be performed to each of the supplementary frames by referring to the luminance of the reference frame, so that the difference between the luminance of each of the adjusted supplementary frames and the luminance of the reference frame can be further reduced. The luminance of various RAW images to be processed is almost equal, and the obtained image values of the fused images remain a linear relationship with the luminance of the actual object, which can effectively solve the problem that due to the existence of a plurality of luminance in the image, the final obtained image is prone to the phenomenon of unnatural luminance transition.

The above description is merely a summary of the technical solutions of the present disclosure. In order to more clearly know the elements of the present disclosure to enable the implementation according to the contents of the description, and in order to make the above and other purposes, features, and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the prior art, the figures that are required to describe the embodiments or the prior art will be briefly introduced below. Apparently, the figures that are described below are embodiments of the present disclosure, and a person skilled in the art can obtain other figures according to these figures without paying creative work. It should be noted that the ratios in the drawings are merely illustrative and do not represent actual ratios.

FIG. 1 is a flow schematic chart of an image fusion method provided by some embodiments of the present disclosure;

FIG. 2a is a schematic diagram of a reference frame provided by some embodiments of the present disclosure;

FIG. 2b is a schematic diagram of a weight mask provided by some embodiments of the present disclosure;

FIG. 3a is a schematic diagram of a RAW image to be processed provided by some embodiments of the present disclosure;

FIG. 3b is schematic diagram of another RAW image to be processed provided by some embodiments of the present disclosure;

FIG. 4 is a complete flow schematic chart of an image fusion method provided by some embodiments of the present disclosure;

FIG. 5 is a structural schematic diagram of an image fusion apparatus provided by some embodiments of the present disclosure; and

FIG. 6 is a structural schematic diagram of an electronic device provided by some embodiments of the present disclosure.

### DETAILED DESCRIPTION OF THE EMBODIMENTS

The embodiments of the present disclosure are described in detail below. The examples of the embodiments are shown in the drawings, wherein from beginning to end the same or similar labels represent the same or similar elements or elements with the same or similar functions. The following embodiments described by reference to the drawings are exemplary, which are only used to explain the application, but cannot be interpreted as restrictions on the application.

A person skilled in the art can understand that unless specifically stated, the singular forms, such as “a/an”, “one” and “the” used here, may also include plural forms. It should be further understood that the wording “include” used in the specification refers to the existence of features, integers, steps, operations, elements and/or components, but does not exclude the existence or addition of one or more other features, integers, steps, operations, elements, components and/or their groups. It should be understood that when an element is called “connected” or “coupled” to another element, it can be directly connected or coupled to other elements, or there can be intermediate elements. In addition, the “connected” or “coupled” may include wireless connection or wireless coupling. The words “and/or” used here include all or any unit and all combinations of one or more associated list items.

In order to make the objects, the technical solutions, and the advantages of the present disclosure clearer, the embodiments of the present disclosure will be further described in detail in combination with the drawings.

The technical solutions of the present disclosure and how the technical solutions of the present disclosure solve the above technical problems are described in detail with specific embodiments below. The following specific embodiments can be combined with each other, and for the same or similar concepts or processes may not be repeated in some embodiments. In the following part, the embodiments of the present disclosure will be described in combination with the drawings.

The embodiments of the present disclosure provide an image fusion method, referring to FIG. 1 the method includes:
step S101, acquiring at least two RAW images to be processed in a same scenario.

Wherein, the RAW images are also called original images, and are original data of which image sensors of digital cameras, scanners, terminal cameras and other devices convert the captured light source signal into the digital signals. In practical applications, the RAW images will not lose information due to image processing (such as sharpening, increasing color contrast, etc.) and compression. There is a linear luminance relationship between the RAW images. In other words, when the frame images in the video are RAW images, there is a linear luminance relationship between the adjacent frames in the video. The RAW images to be processed in a same scenario refer to that the image contents in different RAW images to be processed are fundamentally same, that is the difference between the image contents of various RAW images to be processed is less than a certain threshold, in other words, the difference of the frame between the images meets the preset conditions. For example, a user shoots two RAW images at a same location and in a same posture, the two RAW images are only shot at different time, but the image contents of the two RAW images are almost identical the same (the difference of the frame in the images meets the preset conditions), at this time, the two RAW images are images in the same scenario. Wherein a method of acquiring the RAW images to be processed in a same scenario is not limited in the embodiments of the present disclosure, for instance, a plurality of adjacent frames in the same video can be regarded as the RAW images to be processed, or the images that the image acquisition interval is less than the set interval can be regarded as the RAW images to be processed, or the images obtained by the way of continuous shooting can be regarded as the RAW images to be processed.

Step S102, regarding one of the at least two RAW images to be processed as a reference frame, the others as supplementary frames, and determining a luminance relationship between each of the supplementary frames and the reference frame.

Wherein, the method of selecting which image as the reference frame from the RAW images to be processed is not limited in the embodiments of the present disclosure. For example, an image optionally selected from the RAW images to be processed can be regarded as the reference frame, furthermore the conditions can be set to determine the reference frame. When the exposure parameters of the RAW images to be processed meet the setting conditions, the RAW image to be processed is regarded as the reference frame. For example, the setting condition can be that the exposure parameters are within a specific range, if there are exposure parameters of a plurality of the RAW images to be processed in a specific range, any frame that meets the conditions can be selected as the reference frame, or the RAW images to be processed with the exposure parameters closest to the preset parameters can be selected as the reference frame. Further, after selecting an image that meets the setting conditions as the reference frame, other RAW images to be processed can be regarded as the supplementary frames.

In an embodiment, if the acquired RAW images to be processed includes an image 1, an image 2, . . . , and an image 10, the setting conditions for selecting the reference frame are that the exposure parameters of the images meet the setting conditions. Wherein, only the exposure parameters of the image 2 meet the setting conditions, then the image 2 is regarded as the reference frame, the image 1, the image 3 . . . , and the image 10 are regarded as the supplementary frames.

Further, in practical applications, the image information of the images may include luminance, and after determining the reference frame and the supplementary frames, the luminance relationship between each of the supplementary frames and the reference frame may also be determined.

Wherein, the luminance relationship may be expressed in a plurality of ways, for example, the way of ratio may be used to express the luminance relationship between each of the supplementary frames and the reference frame. When the luminance of the supplementary frame is the same to the luminance of the reference frame, the luminance relationship between the supplementary frame and the reference frame is 1:1. When the luminance of the supplementary frame is half of the luminance of the reference frame, the luminance relationship between the supplementary frame and the reference frame is 1:2.

Step S103, for each of the supplementary frames, linearly adjusting the luminance of pixels in the supplementary frame based on the luminance relationship to obtain an adjusted supplementary frame.

In practical applications, after determining the luminance relationship between each of the supplementary frames and the reference frame, the luminance of pixels in each of the supplementary frames may be linearly adjusted according to the luminance relationship between each of the supplementary frames and the reference frame, to obtain an adjusted supplementary frame. Wherein the specific implementation methods of the adjustment are not limited in the embodiment of the present disclosure.

In an embodiment, if the supplementary frames include a supplementary frame 1 and a supplementary frame 2, and the luminance relationship between the supplementary frame 1 and the reference frame is 1:4, the luminance relationship between the supplementary frame 2 and the reference frame is 1:2; further, the luminance of pixels in the supplementary frame 1 may be linearly adjusted according to the luminance relationship between the supplementary frame 1 and the reference frame. For example, the luminance of pixels in the supplementary frame 1 is multiplied by 4, to obtain an adjusted supplementary frame 1. The luminance of pixels in the supplementary frame 2 may be linearly adjusted according to the luminance relationship between the supplementary frame 2 and the reference frame. For example, the luminance of pixels in the supplementary frame 2 is multiplied by 2, to obtain an adjusted supplementary frame 2.

Step S104, fusing each of the adjusted supplementary frames and the reference frame to obtain a fused image.

Wherein when each of the adjusted supplementary frames and the reference frame are fused, the image sizes of the adjusted supplementary frames and the reference frame are the same. If there are images with different sizes, the images with different sizes may be processed, to make the sizes of all images are the same. In practical applications, when the RAW images to be processed are acquired, there are images with different sizes, the images with different sizes may be pre-processed before performing the subsequent steps. Wherein the methods to process the image size are not limited in the embodiment of the present disclosure.

In practical applications, after adjusting each of the supplementary frames, each of the adjusted supplementary frames and the reference frame may be fused to obtain a fused image. Wherein specific fusion methods are not limited in the embodiment of the present disclosure.

In the embodiments of the present disclosure, a linear luminance transformation can be performed to each of the supplementary frames by referring to the luminance of the reference frame, so that the difference between the luminance of each of the adjusted supplementary frames and the luminance of the reference frame can be further reduced, and the luminance of various processed RAW images to be processed is almost equal, which can effectively solve the problem that due to the existence of a plurality of luminance in the image, the final obtained image is prone to the phenomenon of unnatural luminance transition, and ensure that the image value of the obtained fused image still remains a linear relationship with the luminance of an actual object.

In optional embodiments of the present disclosure, the method further includes:
acquiring a weight characteristic diagram of each of the RAW images to be processed,
wherein the weight characteristic diagram includes a weight value of each pixel in the RAW images to be processed; and
the step of fusing each of the adjusted supplementary frames and the reference frame to obtain a fused image includes:
fusing each of the adjusted supplementary frames and the reference frame based on the weight characteristic diagram of each of the RAW images to be processed, to obtain a fused image.

Wherein, the weight characteristic diagram is used to represent the value of each pixel in each RAW image to be processed, that is, the weight of each pixel in the RAW image to be processed can be obtained via the weight characteristic diagram of each RAW image to be processed. When acquiring the weight characteristic diagram of each RAW image to be processed, the weight characteristic diagram of each RAW image to be processed may be input into the neural network, respectively, to obtain the weight characteristic diagram of each RAW image to be processed.

Further, when the images are being fusing, according to the weight characteristic diagram corresponding to each RAW image to be processed, various RAW images to be processed may be fused to obtain the fused image. Wherein specific fusion methods are not limited in the embodiment of the present disclosure, such as Alpha fusion, pyramid fusion, gradient fusion and other fusion methods.

In an embodiment, the RAW images to be processed include the reference frame, the supplementary frame 1 and the supplementary frame 2. The reference frame, the supplementary frame 1 and the supplementary frame 2 may be input into the neural network to obtain the weight characteristic diagram of the reference frame, the weight characteristic diagram of the supplementary frame 1 and the weight characteristic diagram of the supplementary frame 2. Further the luminance relationship between the supplementary frame 1 and the reference frame, the luminance relationship between the supplementary frame 2 and the reference frame may be determined. And based on the luminance relationship between the supplementary frame 1 and the reference frame, the luminance of pixels in the supplementary frame 1 is adjusted to obtain an adjusted supplementary frame 1. Based on the luminance relationship between the supplementary frame 2 and the reference frame, the luminance of pixels in the supplementary frame 2 is adjusted to obtain an adjusted supplementary frame 2. Then, according to the weight characteristic diagram of the reference frame, the weight characteristic diagram of the supplementary frame 1 and the weight characteristic diagram of the supplementary frame 2, the reference frame, the adjusted supplementary frame 1 and the adjusted supplementary frame 2 are fused.

In actual life, since the images with a plurality of exposure parameters are obtained at the same time, the moving objects in the image may be in different positions on different image. In the fused image, the moving objects may appear translucent pseudo-images, also known as “ghosts”. In embodiments of the present disclosure, since the weight characteristic diagram is derived from the semantic recognition of the neural network, reasonable weights can be given to areas that are difficult to determine and process by traditional methods such as the moving area, and thus the obtained fused images may have no “ghosts”.

In optional embodiments of the present disclosure, the neural network is trained by the following methods:
acquiring a training sample set, wherein the training sample set includes training
images corresponding to at least one scenario, the training images of each scenario are at least two images, for at least two images of each scenario, one image is regarded as a sample reference frame, and the other images are regarded as sample supplementary frames;
performing a linear luminance transformation on each of the training images to obtain various transformed training images, and based on the transformed training images, training an initial network until a loss function of the initial network converges, and determining the initial network when the loss function converges as the neural network;
wherein, the initial network is a neural network with an image as an input and a weight characteristic diagram of the image as an output, the loss function characterizes the error between sample fusion images corresponding to the same scenario and the sample reference frame, the sample fusion images are obtained by fusing the transformed training images according to a weight characteristic diagram of each training image corresponding to the same scenario.

Wherein, the initial network may be a fully convolutional neural network (FCN), a convolutional neural network (CNN), a deep neural network (DNN) and other neural network, the types of the initial network are not limited in the embodiments of the present disclosure. In addition, a network structure of the initial network may be designed according to the computer vision tasks, or, the network structure of the initial network may use at least one part of an existing network structure, such as: a deep residual network (Res Net) or a dense convolutional network (Dense Net) and so on. The network structure of the initial network is not limited in the embodiments of the present disclosure. Taking the initial network as the fully convolutional neural network as an example, the embodiment of the present disclosure is described below.

The training images in the training sample set are used to train the sample data of the neural network, the training images in the training sample set are at least corresponding to a scenario, and the training images of each scenario are at least two images, for the images in each scenario, one image is selected as the sample reference frame, and the other images are regarded as the sample supplementary frames. Wherein the methods of selecting the sample reference frame are not limited in the embodiments of the present disclosure. For example, an image optionally selected from the training images may be regarded as the sample reference frame, or when the image information of the training image meets the setting conditions, the training image is regarded as the sample reference frame, and the methods of acquiring the training images in a same scenario are not limited in the embodiments of the present disclosure, for example, a plurality of adjacent frames in the same video can be selected as the training images in a same scenario.

Accordingly, the linear luminance transformation may be performed on each of the training images, to obtain various transformed training images, and the acquired initial network is trained by various transformed training images, when the loss function of the initial network converges, the initial network when the loss function of the initial network converges is determined as the neural network. Wherein the initial network is the fully convolutional neural network with an image as the input and a weight characteristic diagram of the image as the output, and the linear luminance transformation may convert the training images to the images with a reduced dynamic range.

During the training, the training images in the training sample set may be input into the initial network, to obtain the weight characteristic diagram of each training image. For the training images in a scenario, according to the output weight characteristic diagram of the training images in the scenario, various transformed training images in the scenario are fused to obtain sample fusion images, and the error between the obtained sample fusion images and the sample reference frame in the scenario is determined whether to meet the conditions (the loss function value obtained according to the sample fusion images and the sample reference frame in the scenario is determined whether to converge). If the conditions are not met, the parameters in the initial network are adjusted, and the training images in the training sample set are input into the initial network again to obtain the weight characteristic diagram of each training image. For the training images in each scenario, according to the output weight characteristic diagram of the training images in the scenario, various transformed training images in the scenario are fused to obtain sample fusion images again and the error between the obtained sample fusion images at present and the sample reference frame in the scenario is determined whether to meet the conditions. If the conditions are not met, then the initial network is trained again based on the training images in the training sample set until the error between the sample fusion image corresponding to the same scenario and the sample reference frame of the scenario meets the condition.

In optional embodiments of the present disclosure, acquiring a training sample set includes:
acquiring an initial training sample set, wherein the initial training sample set includes initial images corresponding to at least one scenario, and the initial images of each scenario are at least two images;
on the condition that the initial images are the low dynamic range images, regarding the initial images as training images of each scenario;
on the condition that the initial images are the high dynamic range images, converting each of the initial images into a low dynamic range image corresponding to each of the initial images; and
regarding the low dynamic range image corresponding to each of the initial images of each scenario as a training image of each scenario.

In practical applications, the initial training sample set may be acquired, the initial training images of the initial training sample set are at least corresponding to one scenario, and the initial images of each scenario are at least two images. Wherein if acquired initial images are the low dynamic range images, the acquired initial images can be directly regarded as the training images of the training sample set. If the acquired initial images are the high dynamic range images, each of the high dynamic range images may be converted into corresponding low dynamic range image, then the low dynamic range image corresponding to each of the high dynamic range image of each scenario is regarded as the training image of each scenario. The methods of converting the high dynamic range image to the low dynamic range image are not limited in the embodiments of the present disclosure.

In embodiments of the present disclosure, after converting the high dynamic range image to the low dynamic range image, and then based on the neural network, the corresponding weight characteristic diagram is obtained, reasonable weights can be given to areas that are difficult to determine and process by traditional methods such as the moving area, and thus the obtained fused images may have no “ghosts”.

In optional embodiments of the present disclosure, when the RAW images to be processed are high dynamic range images, the step of acquiring a weight characteristic diagram of each of the RAW images to be processed includes:
converting each of the RAW images to be processed into a low dynamic range image to obtain converted RAW images to be processed; and inputting each of the converted RAW images to be processed to a neural network to obtain the weight characteristic diagram of each of the RAW images to be processed.

In practical applications, since the neural network is obtained based on the training images in the training sample set, and the training images in the training sample set are low dynamic range images, in other words, the input images of the trained neural network are also low dynamic range images. Further, if the acquired RAW images to be processed are high dynamic range images, at the moment, after converting the RAW images to be processed to low dynamic range images, each of the converted RAW images to be processed is input into the neural network to obtain the weight characteristic diagram of each of the RAW images to be processed.

Further, for each of the supplementary frames, based on the determined luminance relationship of the supplementary frames and the reference frame, the luminance of pixels in the converted supplementary frames may be adjusted to obtain the adjusted supplementary frames. Then, based on the output weight characteristic diagram of each of the RAW images to be processed, each of the adjusted supplementary frames and the converted reference frame are fused to obtain a fused image.

In optional embodiments of the present disclosure, determining the luminance relationship between each of the supplementary frames and the reference frame includes:
acquiring an exposure parameter of each of the RAW images to be processed; and
for each of the supplementary frames, according to an exposure parameter of the reference frame and an exposure parameter of the supplementary frame, determining the luminance relationship between the supplementary frame and the reference frame.

In practical applications, there are a plurality of methods to determine the luminance relationship between each of the supplementary frames and the reference frame. As an optional method, the exposure parameters of each of the RAW images to be processed may be acquired, the exposure parameters refer to the exposure parameters when each RAW image to be processed is shot, in other words, if the exposure parameters set when different RAW image to be processed are shot are different, the exposure parameters of the different RAW image to be processed are different. Wherein the methods of acquiring the exposure parameters of each RAW image to be processed are not limited in the embodiments of the present disclosure, for example, the exposure parameters of each RAW image to be processed can be acquired by acquiring the algorithm of exposure parameters.

Further, when the luminance relationship between each of the supplementary frames and the reference frame is determined, for each supplementary frame, according to the acquired exposure parameters of the supplementary frame and the exposure parameters of the reference frame, the luminance relationship between the supplementary frame and the reference frame may be obtained.

In optional embodiments of the present disclosure, the exposure parameter includes an aperture size, a shutter time and a sensor gain;
the step of according to an exposure parameter of the reference frame and an exposure parameter of the supplementary frame, determining the luminance relationship between the supplementary frame and the reference frame includes:
determining an incidence relation of the supplementary frame and the reference frame corresponding to each of the exposure parameters; and
determining the luminance relationship between the supplementary frame and the reference frame according to the incidence relation of the supplementary frame and the reference frame corresponding to each of the exposure parameters.

In practical applications, the exposure parameters of each of the RAW images to be processed may include the aperture size, the shutter time and the sensor gain and so on set when the RAW image is shot. Further, for each of the supplementary frames, the incidence relation of the supplementary frame and the reference frame corresponding to each of the exposure parameters is determined. That is, for each supplementary frame, there is the incidence relation between the aperture size of the supplementary frame and the aperture size of the reference frame, the incidence relation between the sensor gain of the supplementary frame and the sensor gain of the reference frame, and the incidence relation between the shutter time of the supplementary frame and the shutter time of the reference frame. Wherein the expression ways of incidence relation of each of the exposure parameters are not limited in the embodiments of the present disclosure. For example, the way of ratio may be used for expression, at the moment, the incidence relation of the supplementary frame and the reference frame corresponding to the aperture size may be expressed as R_{aperture size}, the incidence relation of the supplementary frame and the reference frame corresponding to the shutter time may be expressed as R_{shutter time}, the incidence relation of the supplementary frame and the reference frame corresponding to the sensor gain may be expressed as R_{sensor gain}.

Accordingly, for each supplementary frame, according to the incidence relation of the supplementary frame and the reference frame corresponding to each of the exposure parameters, the luminance relationship between the supplementary frame and the reference frame may be determined. Wherein the implementation methods of according to the incidence relation of the supplementary frame and the reference frame corresponding to each of the exposure parameters, determining the luminance relationship between the supplementary frame and the reference frame are not limited in the embodiments of the present disclosure.

In optional embodiments of the present disclosure, if the exposure parameter is the aperture size, the incidence relation is the ratio of the square value of the aperture size of the supplementary frame to the square value of the aperture size of the reference frame;
if the exposure parameter is the shutter time, the incidence relation is the ratio of the shutter time of the reference frame to the shutter time of the supplementary frame; and
if the exposure parameter is the sensor gain, the incidence relation is the ratio of the sensor gain of the supplementary frame to the sensor gain of the reference frame.

In practical applications, if the way of ratio is used to express the incidence relation of each of the exposure parameters, as an optional way, the product of the incidence relation of the supplementary frame and the reference frame corresponding to various exposure parameters may be regarded as the luminance relationship between the supplementary frames and the reference frame.

In an embodiment, if there are a reference frame a and a supplementary frame b, the aperture size of the reference frame a uses fa to express, the shutter time uses sa to express, the sensor gain uses ga to express, the aperture size of the supplementary frame b uses fb to express, the shutter time uses sb to express, the sensor gain uses gb to express. At the moment, for the supplementary frame b, the incidence relation of the supplementary frame b and the reference frame a corresponding to the aperture size is R_{aperture size} (fa, fb)=(fb)²/(fa)², the incidence relation of the supplementary frame b and the reference frame a corresponding to the shutter time is R_{shutter time} (sa, sb)=sa/sb, the incidence relation of the supplementary frame b and the reference frame a corresponding to the sensor gain is R_{sensor gain} (ga, gb)=gb/ga, at the moment, the luminance relationship between the supplementary frame b and the reference frame a may be Ratio(a, b)=R_{aperture size} *R_{shutter time}*R_{sensor gain}.

In optional embodiments of the present disclosure, determining the luminance relationship between each of the supplementary frames and the reference frame further includes:
determining a weight mask based on a luminance of each pixel in the reference frame;
adjusting a luminance of each pixel in each of the RAW images to be processed based on the weight mask;
for each of the RAW images to be processed, determining a luminance of the RAW images to be processed based on the luminance of each pixel of adjusted RAW images to be processed; and
for each of the supplementary frames, determining the luminance relationship between the supplementary frame and the reference frame based on a luminance of the supplementary frame and a luminance of the reference frame.

In practical applications, if the luminance of the pixels in the reference frame meets the preset conditions, then the pixel value of the pixel corresponding to the weight mask is 1, if the luminance of the pixels in the reference frame does not meet the preset conditions, then the pixel value of the pixel corresponding to the weight mask is 0.

Wherein, the mask refers to that for the pre-fabricated images containing the region of interest, the mask may be used to block all or part of the images to be processed, so that it does not participate in processing or only the shielding area is processed. Wherein, the mask in the embodiments of the present disclosure may include the luminance weight of the pixels corresponding to each of the RAW images to be processed, thus the mask is called the weight mask.

In practical applications, if the exposure parameters of each of the RAW images to be processed cannot be acquired, the weight mask may also be determined according to the luminance of each pixel in the reference frame. Wherein, the weight mask includes the luminance weight of the pixels corresponding to each of the RAW images to be processed, when the luminance of the pixels in the reference frame meets the preset conditions, the pixel value corresponding to the pixel in the weight mask is 1. If the luminance of the pixels in the reference frame does not meet the preset conditions, the pixel value corresponding to the pixel in the weight mask is 0. Wherein, the preset conditions are not limited in the embodiments of the present disclosure, for example, the preset condition may be that the luminance of the pixels is between 20% and 80% (including 20% and 80%) of the preset saturation value.

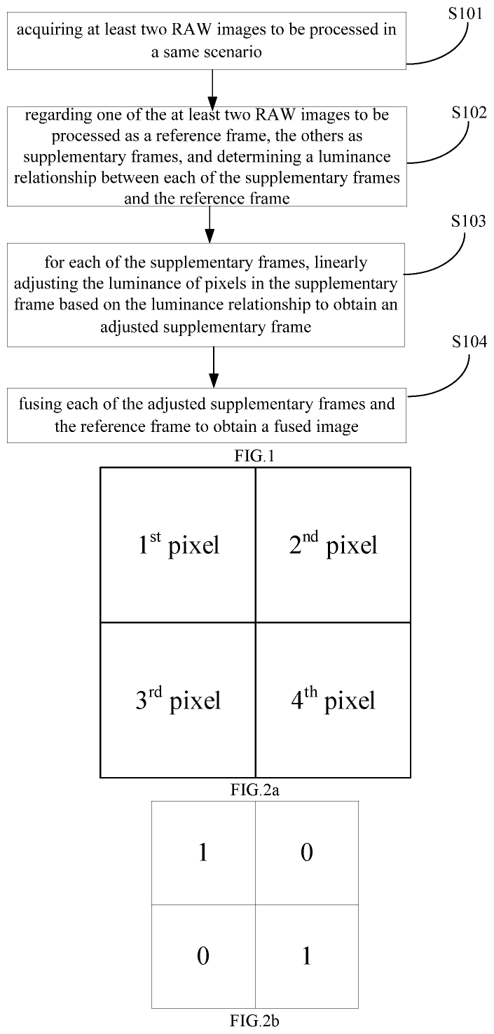

In an embodiment, referring to the FIG. 2a, if the pixel size of the reference frame is an image of 2*2 (including 4 pixels), wherein, the luminance of the 1^{st} pixel and the 4^{th} pixel is between 20% and 80% of the preset saturation value, at the moment, referring to the FIG. 2b, in the weight mask, the pixel value corresponding to the 1^{st} pixel and the 4^{th} pixel is 1, the pixel value corresponding to the 2^{nd} pixel and the 3^{rd} pixel is 0.

Further, the luminance of each pixel in each of the RAW images to be processed based on the weight mask may be adjusted, that is the luminance of each pixel in each of the RAW images to be processed and the weight mask are performed a bit arithmetic, when the pixel in the RAW images to be processed is corresponding to the location that the pixel value in the weight mask is 1, the luminance of the pixel in the RAW image to be processed remains the original value. When the pixel in the RAW images to be processed is corresponding to the location that the pixel value in the weight mask is 0, the luminance of the pixel in the RAW image to be processed is 0.

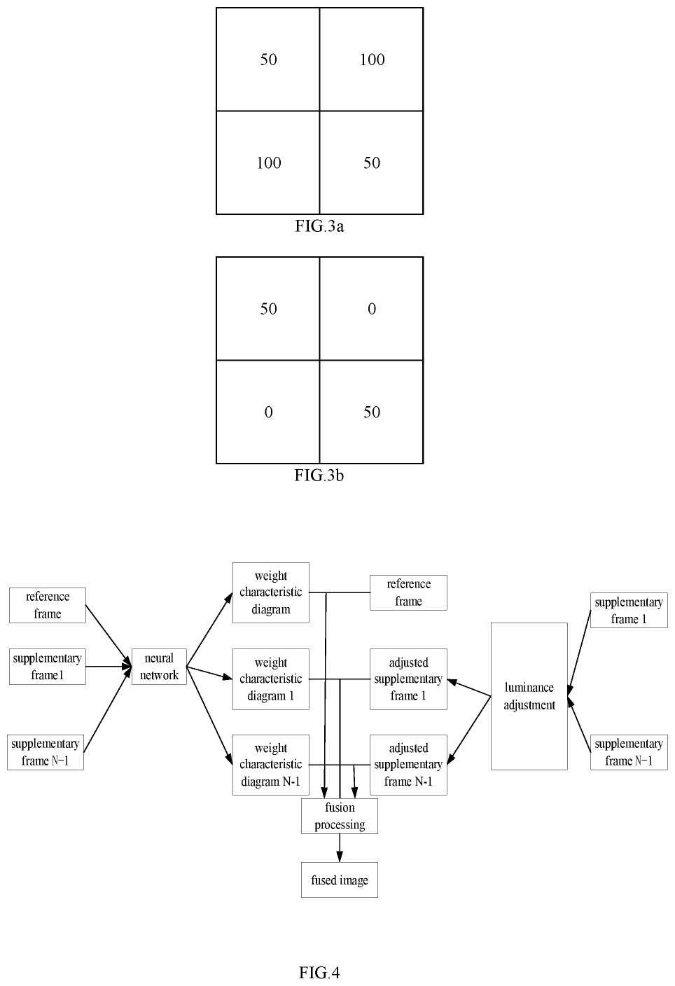

In an embodiment, referring to the FIG. 3a, if the pixel size of the RAW image to be processed is an image of 2*2 (including 4 pixels), wherein, the luminance of the 1^{st} pixel and the 4^{th} pixel is 50, the luminance of the 2^{nd} pixel and the 3^{rd} pixel is 100, and the weight mask refers to the FIG. 2b. Further, since the 1^{st} pixel and the 4^{th} pixel in the RAW image to be processed correspond to the pixel of which the pixel value is 1 in the weight mask, the luminance of the 1^{st} pixel and the 4^{th} pixel in the RAW image to be processed remains the original value (that is 50). While the 2^{nd} pixel and the 3^{rd} pixel correspond to the pixel of which the pixel value is 0 in the weight mask, and the luminance of the 2^{nd} pixel and the 3^{rd} pixel in the RAW image to be processed is 0, at the moment, the luminance of each pixel in the obtained adjusted RAW image to be processed refers to FIG. 3b.

Further, for each of the RAW images to be processed, the luminance of the RAW images to be processed is determined based on the luminance of each pixel in the adjusted RAW images to be processed. Wherein specific implementation methods of determining the luminance of the RAW images to be processed are not limited in the embodiment of the present disclosure. For example, the method that the luminance of the adjusted pixels is weighted average may be used to determine the luminance of the RAW images to be processed. The specific formula is as follows:

L(X)=average(X*mask)

Wherein, L(X) represents the luminance of the RAW images to be processed. X represents an RAW image X to be processed, mask represents the weight mask. X*mask represents the luminance of each pixel in the RAW image X to be processed is adjusted based on the weight mask, to obtain the adjusted luminance of each pixel in the RAW image X to be processed, then the adjusted luminance of each pixel in the RAW image X to be processed is performed an additive operation, and average (X*mask) represents the adjusted luminance of each pixel in the RAW image X to be processed is performed a mean operation.

In an embodiment, if the RAW image G to be processed is an image of 2*2 (including 4 pixels), wherein, the adjusted luminance of the 1^{st} pixel and the 4^{th} pixel is 50, the adjusted luminance of the 2^{nd} pixel and the 3^{rd} pixel is 0, at the moment, the luminance of the RAW image G to be processed is L(G)=(50+50+0+0)/4=25.

Accordingly, for each supplementary frame, based on the determined luminance of the supplementary frame and the determined luminance of the reference frame, the luminance relationship between the supplementary frame and the reference frame may be determined. Wherein, how to determine the luminance relationship is not limited in the embodiments of the present disclosure, for example, the ratio relation between each of the supplementary frames and the reference frame may be directly regarded as the luminance relationship between each of the supplementary frames and the reference frame. For example, the luminance of the supplementary frame is 50, the luminance of the reference frame is 100, at the moment, the ratio relation between the supplementary frame and the reference frame is 1:2, that is, the luminance relationship between the supplementary frame and the reference frame is 1:2.

Referring to FIG. 4, the solution provided by the embodiments of the present disclosure is described in detail in combination with the specific application scenario below.

More than 1000 HDR videos are shot by devices with high dynamic RAW image output ability, such as a single-inverse camera, a high dynamic industrial camera and so on. Wherein, each HDR video is corresponding to a scenario, a plurality of adjacent frame images (F1, F2, . . . , Fn) are randomly selected from each HDR video as the initial training images in the same scenario, F1 is selected from F1, F2, . . . , Fn as the sample reference frame. Further, a plurality of the frame images (F1, F2, . . . , Fn) are performed the linear luminance transformation, to obtain n frames of low dynamic range images (LF1, LF2, . . . , LFn), n frames of low dynamic range images (LF1, LF2, . . . , LFn) are performed the linear luminance inverse transformation, to obtain n frames images (FF1, FF2, . . . , FFn) to be fused.

Further, the fully convolutional neural network with a encoder-decoder structure is designed, the n frames of the low dynamic range images (LF1, LF2, . . . , LFn) are input into the fully convolutional neural network, to output n frames of the weight characteristic diagrams (W1, W2, . . . , Wn) with the same size to (LF1, LF2, . . . , LFn), and according to the output weight characteristic diagrams, the images (FF1, FF2, . . . , FFn) to be fused are performed the fusion processing, to obtain a fused image Y (that is, Y=FF1*W1+FF2*W2+ . . . +FFn*Wn). And based on the Y corresponding to various scenarios and the reference frames corresponding to various scenarios, the error loss function value is calculated. When the number of loss function convergence reaches the threshold, the training is completed and the neural network described in this the embodiment of the present disclosure is obtained.

Further, N RAW images to be processed are acquired, and the N RAW images to be processed are low dynamic range images (if the N RAW images to be processed are high dynamic range images, then the N RAW images to be processed are converted to low dynamic range images), the N RAW images to be processed are input into the neural network, to obtain weight characteristic diagrams (weight characteristic diagram 1, weight characteristic diagram 2, . . . , and weight characteristic diagram N) corresponding to various RAW images to be processed. In the N RAW images to be processed, one RAW image to be processed with the exposure parameter meeting the set requirement is selected as the reference frame, the other RAW images to be processed are regarded as the supplementary frames (that is, supplementary frame 1, . . . , and supplementary frame N-1). The luminance relationship between each of the supplementary frames and the reference frame is determined, and based on the determined luminance relationship between the supplementary frame and the reference frame, the luminance of pixels in various supplementary frames is adjusted, to obtain various adjusted supplementary frames (adjusted supplementary frame 1, . . . , and adjusted supplementary frame N-1). Based on the weight characteristic diagram of each of the RAW images to be processed, each of the adjusted supplementary frames and the reference frame are fused to obtain a fused image.

The solution provided by the embodiments of the present disclosure is described in detail in combination with a system of image fusion below. In the system of image fusion, a RAW acquisition module, a neural network module, a software fusion module and a post-processing module are included.

Wherein, the RAW acquisition module communicates with the sensor through the interface provided by the operating system and driver to issue the exposure strategy (that is which exposure parameters changing are used to shoot the RAW image to be processed), and obtain the RAW images to be processed with different exposure parameters, then the RAW images to be processed with different exposure parameters are input into the neural network module (the neural network module can be run on a central processing unit (CPU), a graphics processing unit (GPU), neural-network process units (NPU), a digital signal processing (DSP) and other hardware), to obtain the weight characteristic diagram of various RAW images to be processed, then various RAW images to be processed are performed fusion processing by the software fusion module to obtain the fused images (that is obtain high dynamic range RAW images), the obtained fused images are input into the post-processing module to obtain the visual images.

In practical applications, the system to realize the image fusion may include a sensor interface, a memory interface, a neural network accelerator, a fusion processing module, an image signal processing (ISP) interface or a post-processing module. Wherein the sensor interface is configured for data communication with image sensors. Its communication interface may be direct communication or indirect communication through memory interface. After obtaining multi-frame RAW images to be processed with different exposure parameters, the multi-frame RAW images to be processed with different exposure parameters are input into the neural network accelerator to obtain the weight characteristic diagram of each of the RAW images to be processed, and then the RAW images to be processed and the weight characteristic diagrams of each of the RAW images to be processed are input into the fusion processing module to obtain the RAW images with high dynamic range, which are input into the ISP through the ISP interface, or input into the post-processing module for subsequent processing to obtain visual images.

FIG. 5 is a structural schematic diagram of an image fusion apparatus provided by some embodiments of the present disclosure. Referring to the FIG. 5, the image fusion apparatus 60 includes: an image acquisition module 601, a luminance relationship determination module 602, a luminance adjustment module 603 and an image fusion module 604, wherein:
the image acquisition module 601 configured for acquiring at least two RAW images to be processed in a same scenario;
the luminance relationship determination module 602 configured for regarding one of the at least two RAW images to be processed as a reference frame, the others as supplementary frames, and determining a luminance relationship between each of the supplementary frame and the reference frame;
the luminance adjustment module 603 configured for, for each of the supplementary frames, linearly adjusting the luminance of pixels in the supplementary frame based on the luminance relationship to obtain an adjusted supplementary frame; and
the image fusion module 604 configured for fusing each of the adjusted supplementary frames and the reference frame to obtain a fused image.

In the optional embodiments of the present disclosure, the apparatus further includes a weight characteristic diagram acquisition module 605, specifically configured to:
acquire a weight characteristic diagram of each of the RAW images to be processed, wherein the weight characteristic diagram includes a weight value of each pixel in the RAW images to be processed; and
when the weight characteristic diagram acquisition module fuse each of the adjusted supplementary frames and the reference frame, specifically configured to:
fuse each of the adjusted supplementary frames and the reference frame based on the weight characteristic diagram of each of the RAW images to be processed.

In the optional embodiments of the present disclosure, when the weight characteristic diagram acquisition module is acquiring the weight characteristic diagram of each of the RAW images to be processed, specifically configured to:
when the RAW images to be processed are high dynamic range images, convert each of the RAW images to be processed into a low dynamic range image to obtain converted RAW images to be processed; and
input each of the converted RAW images to be processed to a neural network to obtain the weight characteristic diagram of each of the RAW images to be processed.

In the optional embodiments of the present disclosure, the apparatus further includes a training module 606, wherein the training module 606 obtains the neural network through the following methods:
acquire a training sample set, wherein the training sample set includes training images corresponding to at least one scenario, the training images of each scenario are at least two images, for at least two images of each scenario, one image is regarded as a sample reference frame, and the other images are regarded as sample supplementary frames;
perform a linear luminance transformation on each of the training images to obtain various transformed training images, and based on the transformed training images, training an initial network until a loss function of the initial network converges, and determining the initial network when the loss function converges as the neural network;
wherein, the initial network is a neural network with an image as an input and a weight characteristic diagram of the image as an output, the loss function characterizes the error between sample fusion images corresponding to the same scenario and the sample reference frame, the sample fusion images are obtained by fusing the transformed training images according to a weight characteristic diagram of each training image corresponding to the same scenario.

In the optional embodiments of the present disclosure, when the training module 606 is acquiring a training sample set, the training module is specifically configured to:
acquire an initial training sample set, wherein the initial training sample set includes initial images corresponding to at least one scenario, and the initial images of each scenario are at least two images;
on the condition that the initial images are the low dynamic range images, regarding the initial images as training images of each scenario;
on the condition that the initial images are the high dynamic range images, converting each of the initial images into a low dynamic range image corresponding to each of the initial images; and
regard the low dynamic range image corresponding to each of the initial images of each scenario as a training image of each scenario.

In the optional embodiments of the present disclosure, when the luminance relationship determination module 602 is determining a luminance relationship between each of the supplementary frame and the reference frame, the luminance relationship determination module is specifically configured to:
acquire an exposure parameter of each of the RAW images to be processed; and
for each of the supplementary frames, according to an exposure parameter of the reference frame and an exposure parameter of the supplementary frame, determining the luminance relationship between the supplementary frame and the reference frame.

In the optional embodiments of the present disclosure, the exposure parameter includes an aperture size, a shutter time and a sensor gain;
the step of according to an exposure parameter of the reference frame and an exposure parameter of the supplementary frame, determining the luminance relationship between the supplementary frame and the reference frame includes:
determining an incidence relation of the supplementary frame and the reference frame corresponding to each of the exposure parameters; and
determining the luminance relationship between the supplementary frame and the reference frame according to the incidence relation of the supplementary frame and the reference frame corresponding to each of the exposure parameters;

In the optional embodiments of the present disclosure, if the exposure parameter is the aperture size, the incidence relation is the ratio of the square value of the aperture size of the supplementary frame to the square value of the aperture size of the reference frame;
if the exposure parameter is the shutter time, the incidence relation is the ratio of the shutter time of the reference frame to the shutter time of the supplementary frame; and
if the exposure parameter is the sensor gain, the incidence relation is the ratio of the sensor gain of the supplementary frame to the sensor gain of the reference frame.

In the optional embodiments of the present disclosure when the luminance relationship determination module 602 is determining the luminance relationship between each of the supplementary frames and the reference frame, the luminance relationship determination module is specifically configured to:
determine a weight mask based on a luminance of each pixel in the reference frame;
adjust a luminance of each pixel in each of the RAW images to be processed based on the weight mask;
for each of the RAW images to be processed, determine a luminance of the RAW images to be processed based on the luminance of each pixel of adjusted RAW images to be processed; and
for each of the supplementary frames, determine the luminance relationship between the supplementary frame and the reference frame based on a luminance of the supplementary frame and a luminance of the reference frame.

The image fusion apparatus of the embodiments of the present disclosure can execute the image fusion method described in the embodiments of the present disclosure, of which the realization principle is similar, which is not repeated here.

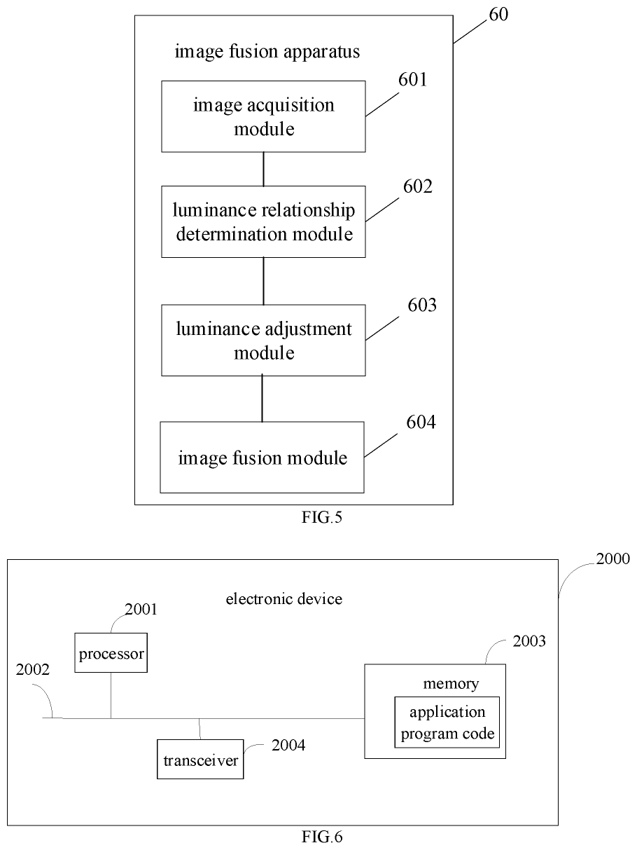

Some embodiments of the present disclosure provide an electronic device, referring to FIG. 6, the electronic device shown in the FIG. 6 includes a processor 2001 and a memory 2003. Wherein the processor 2001 is connected with the memory 2003, for example, they are connected by a bus line 2002. Optionally, the electronic device 2000 may also include a transceiver 2004. It should be noted that, in practical applications, the transceiver 2004 is not limited to one, and the structure of the electronic device 2000 does not constitute the limitation to the embodiments of the present disclosure.

Wherein, the processor 2001 is applied in the embodiments of the present disclosure, and is used to realize the function of various modules shown in the FIG. 5.

The processor 2001 may be a CPU, an universal processor, a DSP, a ASIC, a FPGA or other programmable logic component, transistor logic component, hardware components or any combination of them. The processor 2001 may also be a combination of realizing calculation functions, such as a combination of containing one or more microprocessors, a combination of DSP and microprocessors and so on.

The bus line 2002 may include a path to transmit information among the components described above. The bus line 2002 may be a PCI bus line or an EISA bus line and so on. The bus line 2002 may be classified as an address bus line, a data bus line, a control bus line and so on. For ease of representation, the bus line 2002 is represented by only one coarse line in the FIG. 6, but it does not mean that the bus line only has one bus line or one type of bus line.

The memory 2003 may be ROM or other types of static storage devices which may store static information and instructions, RAM or other types of dynamic storage devices which may store information and instructions, also may be EEPROM, CD-ROM or other optical disk storage, optical disk storage (including compressed optical disk, laser disk, optical disk, digital universal optical disk, blue optical disk and so on), disk storage medium or other magnetic storage devices or any other medium which may be used to carry or store the desired program code in the form of instructions or data structures and can be accessed by the computer, but which is not limited to this.

The memory 2003 is used to store the application program code for executing the solution of the present disclosure, the processor 2001 controls the execution. The processor 2001 is used to execute the application program code stored in the memory 2003 to realize the action of the image fusion apparatus provided by the embodiments shown in FIG. 5.

Some embodiments of the present disclosure provide an electronic device, the electronic device in the embodiments of the present disclosure includes: a processor and a memory, the memory is configured to store machine readable instructions, when the instructions are executed by the processor, the processor executes the image fusion method.

Some embodiments of the present disclosure provide a computer-readable storage medium, the computer-readable storage medium is used to store a computer program, when the computer instructions are executed on the computer, the computer is capable to execute the method of realizing the image fusion.

The nouns and realization principle involved in the computer readable storage medium in this application can specifically refer to an image fusion method in the embodiments of the present disclosure.

Some embodiments of the present disclosure provide a computer program, including a computer-readable code, and when the computer-readable code is executed on an electronic device, the electronic device executes the method of realizing the image fusion.

It should be understood that, although the steps in the flowchart in the attached figure are shown in turn according to the arrow instructions, these steps are not necessarily performed in turn according to the arrow instructions. Unless there is a clear explanation in this specification, the implementation of these steps does not have strict sequence restrictions, which can be implemented in other sequences. Moreover, at least part of the steps in the flow chart attached can include multiple sub-steps or stages. These sub-steps or stages are not necessarily completed at the same time, but can be executed at different times. The execution order is not necessarily carried out in turn, but can be performed in turn or alternately with other steps or at least part of the sub-steps or stages of other steps.

The above is only part of the embodiments of this application, it should be pointed out that for ordinary technical persons in the field, without breaking away from the principle of this application, some improvement and embellishment can also be made, these improvements and embellishment should also be regarded as the scope of protection of this application.

1. An image fusion method, wherein the method comprises:
acquiring at least two RAW images to be processed in a same scenario;
regarding one of the at least two RAW images to be processed as a reference frame, the others as supplementary frames, and determining a luminance relationship between each of the supplementary frames and the reference frame;
for each of the supplementary frames, linearly adjusting the luminance of pixels in the supplementary frame based on the luminance relationship to obtain an adjusted supplementary frame; and
fusing each of the adjusted supplementary frames and the reference frame to obtain a fused image.

2. The method according to claim 1, wherein the method further comprises:
acquiring a weight characteristic diagram of each of the RAW images to be processed, wherein the weight characteristic diagram comprises a weight value of each pixel in the RAW images to be processed; and
the step of fusing each of the adjusted supplementary frames and the reference frame comprises:
fusing each of the adjusted supplementary frames and the reference frame based on the weight characteristic diagram of each of the RAW images to be processed.

3. The method according to claim 2, wherein when the RAW images to be processed are high dynamic range images, the step of acquiring a weight characteristic diagram of each of the RAW images to be processed comprises:
converting each of the RAW images to be processed into a low dynamic range image to obtain converted RAW images to be processed; and
inputting each of the converted RAW images to be processed to a neural network to obtain the weight characteristic diagram of each of the RAW images to be processed.

4. The method according to claim 3, wherein the neural network is trained by the following methods:
acquiring a training sample set, wherein the training sample set comprises training images corresponding to at least one scenario, the training images of each scenario are at least two images, for at least two images of each scenario, one image is regarded as a sample reference frame, and the other images are regarded as sample supplementary frames;
performing a linear luminance transformation on each of the training images to obtain various transformed training images, and based on the transformed training images, training an initial network until a loss function of the initial network converges, and determining the initial network when the loss function converges as the neural network;
wherein, the initial network is a neural network with an image as an input and a weight characteristic diagram of the image as an output, the loss function characterizes the error between sample fusion images corresponding to the same scenario and the sample reference frame, the sample fusion images are obtained by fusing the transformed training images according to a weight characteristic diagram of each training image corresponding to the same scenario.

5. The method according to claim 4, wherein the step of acquiring a training sample set comprises:
acquiring an initial training sample set, wherein the initial training sample set comprises initial images corresponding to at least one scenario, and the initial images of each scenario are at least two images;
on the condition that the initial images are the low dynamic range images, regarding the initial images as training images of each scenario;
on the condition that the initial images are the high dynamic range images, converting each of the initial images into a low dynamic range image corresponding to each of the initial images; and
regarding the low dynamic range image corresponding to each of the initial images of each scenario as a training image of each scenario.

6. The method according to claim 1, wherein the step of determining the luminance relationship between each of the supplementary frames and the reference frame comprises:
acquiring an exposure parameter of each of the RAW images to be processed; and
for each of the supplementary frames, according to an exposure parameter of the reference frame and an exposure parameter of the supplementary frame, determining the luminance relationship between the supplementary frame and the reference frame.

7. The method according to claim 1, wherein the step of determining the luminance relationship between each of the supplementary frames and the reference frame comprises:
determining a weight mask based on a luminance of each pixel in the reference frame;
adjusting a luminance of each pixel in each of the RAW images to be processed based on the weight mask;
for each of the RAW images to be processed, determining a luminance of the RAW images to be processed based on the luminance of each pixel of adjusted RAW images to be processed; and
for each of the supplementary frames, determining the luminance relationship between the supplementary frame and the reference frame based on a luminance of the supplementary frame and a luminance of the reference frame.

8. (canceled)

9. An electronic device, wherein the electronic device comprises a processor and a memory, the memory is configured to store machine readable instructions, when the instructions are executed by the processor, the processor executes the operations comprise:
acquiring at least two RAW images to be processed in a same scenario;
regarding one of the at least two RAW images to be processed as a reference frame, the others as supplementary frames, and determining a luminance relationship between each of the supplementary frames and the reference frame;
for each of the supplementary frames, linearly adjusting the luminance of pixels in the supplementary frame based on the luminance relationship to obtain an adjusted supplementary frame; and
fusing each of the adjusted supplementary frames and the reference frame to obtain a fused image.

10. A nonvolatile computer-readable storage medium,
storing a computer program, wherein the computer-readable storage medium is configured to store computer instructions, when the computer instructions are executed on the computer, the computer is capable to execute the method according to claim 1.

11. (canceled)

12. The electronic device according to claim 9, wherein the operations further comprise:
acquiring a weight characteristic diagram of each of the RAW images to be processed, wherein the weight characteristic diagram comprises a weight value of each pixel in the RAW images to be processed; and
the operation of fusing each of the adjusted supplementary frames and the reference frame comprises:
fusing each of the adjusted supplementary frames and the reference frame based on the weight characteristic diagram of each of the RAW images to be processed.

13. The electronic device according to claim 12, wherein when the RAW images to be processed are high dynamic range images, the operation of acquiring a weight characteristic diagram of each of the RAW images to be processed comprises:
converting each of the RAW images to be processed into a low dynamic range image to obtain converted RAW images to be processed; and
inputting each of the converted RAW images to be processed to a neural network to obtain the weight characteristic diagram of each of the RAW images to be processed.

14. The electronic device according to claim 13, wherein the neural network is trained by the following methods:
acquiring a training sample set, wherein the training sample set comprises training images corresponding to at least one scenario, the training images of each scenario are at least two images, for at least two images of each scenario, one image is regarded as a sample reference frame, and the other images are regarded as sample supplementary frames;
performing a linear luminance transformation on each of the training images to obtain various transformed training images, and based on the transformed training images, training an initial network until a loss function of the initial network converges, and determining the initial network when the loss function converges as the neural network;
wherein, the initial network is a neural network with an image as an input and a weight characteristic diagram of the image as an output, the loss function characterizes the error between sample fusion images corresponding to the same scenario and the sample reference frame, the sample fusion images are obtained by fusing the transformed training images according to a weight characteristic diagram of each training image corresponding to the same scenario.

15. The electronic device according to claim 14, wherein the operation of acquiring a training sample set comprises:
acquiring an initial training sample set, wherein the initial training sample set comprises initial images corresponding to at least one scenario, and the initial images of each scenario are at least two images;
on the condition that the initial images are the low dynamic range images, regarding the initial images as training images of each scenario;
on the condition that the initial images are the high dynamic range images, converting each of the initial images into a low dynamic range image corresponding to each of the initial images; and
regarding the low dynamic range image corresponding to each of the initial images of each scenario as a training image of each scenario.

16. The electronic device according to claim 9, wherein the operation of determining the luminance relationship between each of the supplementary frames and the reference frame comprises:
acquiring an exposure parameter of each of the RAW images to be processed; and
for each of the supplementary frames, according to an exposure parameter of the reference frame and an exposure parameter of the supplementary frame, determining the luminance relationship between the supplementary frame and the reference frame.

17. The electronic device according to claim 9, wherein the operation of determining the luminance relationship between each of the supplementary frames and the reference frame comprises:
determining a weight mask based on a luminance of each pixel in the reference frame;
adjusting a luminance of each pixel in each of the RAW images to be processed based on the weight mask;
for each of the RAW images to be processed, determining a luminance of the RAW images to be processed based on the luminance of each pixel of adjusted RAW images to be processed; and
for each of the supplementary frames, determining the luminance relationship between the supplementary frame and the reference frame based on a luminance of the supplementary frame and a luminance of the reference frame.
